(19) United States
(12) Patent Application Publication
(10) Pub. No.: US 2026/0149915 A1
(43) Pub. Date: May 28, 2026

(54) WIDE COVERAGE SPEAKER

(71) Applicant: Transom Post OpCo, LLC, Hopkinton, MA (US)

(72) Inventors: Joseph J. Kutil, Franklin, MA (US); Adam D. Shulman, Needham, MA (US); Andrew W. Kyte, Cumberland, RI (US); Richard H. Plourde, JR., Clinton, MA (US)

(73) Assignee: Transom Post OpCo, LLC, Hopkinton, MA (US)

(21) Appl. No.: 19/396,638

(22) Filed: Nov. 21, 2025

Related U.S. Application Data
(60) Provisional application No. 63/723,872, filed on Nov. 22, 2024.
(60) Provisional application No. 63/821,191, filed on Jun. 10, 2025.

(51) Int. Cl. H04R 1/28; H04R 1/24; H04R 1/32; H04R 3/14

(52) U.S. Cl. CPC H04R 1/2826; H04R 1/24; H04R 1/2873; H04R 1/323; H04R 3/14

(57) ABSTRACT

A wide coverage speaker is provided that includes an enclosure having a top, a bottom, a central longitudinal axis extending therethrough, and a low frequency cavity therein. An inner sound assembly situated within the enclosure and having an assembly central axis therethrough is also provided, which includes a downward facing woofer positioned within the low frequency cavity and centered about the assembly central axis, an upper chamber situated below the woofer, a tuned low-frequency absorber situated below and in fluid communication with the upper chamber, a plurality of upper-frequency drivers facing outwards in a circular array that is centered about the assembly central axis and situated below the tuned low-frequency absorber, and a cylindrical low-frequency outlet port centered about the assembly central axis and extending downward from the upper chamber and encircled by the circular array.

### CROSS-REFERENCE TO RELATED APPLICATIONS

This application claims priority to and incorporates by reference herein U.S. Provisional Patent Application Ser. No. 63/821,191 filed on Jun. 10, 2025, and U.S. Provisional Patent Application Ser. No. 63/723,872 filed on Nov. 22, 2024.

### FIELD OF THE INVENTION

This invention relates generally to audio components and more particularly to speakers.

### BACKGROUND

In current configurations, providing suitable sound coverage in large rooms generally requires a high quantity of large speakers providing a mid-range and/or high-range frequency response, along with separate subwoofers to provide a low frequency response. Such configurations have a high cost for both the speakers and the installation thereof. In addition, these typical configurations generally provide a less than desirable quality of sound, creating pockets of good and poor sound that are highly dependent on the location of a listener in the room and therefore lack a desired level of sound uniformity within the room.

### SUMMARY OF THE INVENTION

In at least some embodiments, a wide coverage speaker is provided that includes: an enclosure having a top, a bottom, a central longitudinal axis extending therethrough, and a low frequency cavity therein; and an inner sound assembly situated within the enclosure and having an assembly central axis therethrough, the inner sound assembly comprising: a downward facing woofer positioned within the low frequency cavity and centered about the assembly central axis; an upper chamber situated below the woofer; a tuned low-frequency absorber situated below and in fluid communication with the upper chamber; a plurality of upper-frequency drivers facing outwards in a circular array that is centered about the assembly central axis and situated below the tuned low-frequency absorber; and a cylindrical low-frequency outlet port centered about the assembly central axis and extending downward from the upper chamber and encircled by the circular array.

Other embodiments, aspects, and features of the invention will be understood and appreciated upon a full reading of the detailed description and the claims that follow.

### BRIEF DESCRIPTION OF THE DRAWINGS

Embodiments of the invention are disclosed with reference to the accompanying drawings and are for illustrative purposes only. The invention is not limited in its application to the details of construction or the arrangement of the components illustrated in the drawings and the invention is capable of other embodiments or of being practiced or carried out in other various ways. In the drawings:

FIG. 1 is a top perspective view of an exemplary embodiment of a wide coverage speaker;

FIG. 2 is a bottom perspective view of the wide coverage speaker of FIG. 1;

FIG. 3 is a partially exploded perspective view of the wide coverage speaker of FIG. 1;

FIG. 4 is a perspective sectional view taken along lines 4-4 of FIG. 1;

FIG. 5 is a side sectional view taken along lines 4-4 of FIG. 1;

FIG. 6 is a top perspective view of the upper body of the wide coverage speaker of FIG. 1;

FIG. 7 is a bottom perspective view of the upper body of the wide coverage speaker of FIG. 1;

FIG. 8 is a top perspective view of an inner sound assembly of the wide coverage speaker of FIG. 1;

FIG. 9 is a bottom perspective view of the inner sound assembly of FIG. 8;

FIG. 10 is a side view of the inner sound assembly of FIG. 8;

FIG. 11 is a perspective sectional view of the inner sound assembly taken along lines 11-11 of FIG. 8;

FIG. 12 is a side sectional view of the inner sound assembly taken along lines 11-11 of FIG. 8;

FIG. 13 is a top exploded perspective view of the inner sound assembly of FIG. 8; and

FIG. 14 is a bottom exploded perspective view of the inner sound assembly of FIG. 8.

### DETAILED DESCRIPTION

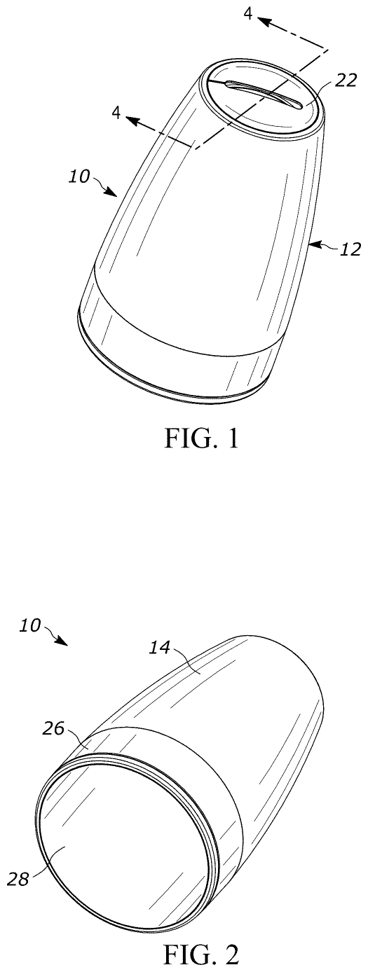

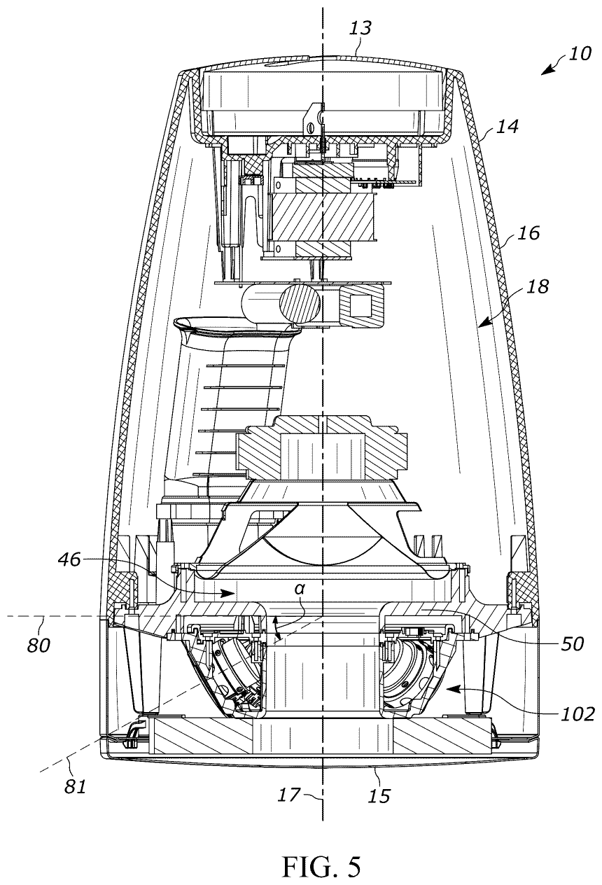

Referring to FIGS. 1-5 various views of a wide coverage speaker 10 are shown in accordance with one exemplary embodiment of the invention. The wide coverage speaker 10 is suitable for various mounting configurations, such as open ceiling commercial applications (e.g., pendant mount, etc.). In at least some embodiments, the wide coverage speaker 10 is a pendant mount speaker, although other mounting styles or configurations may be utilized, including rigid or flexible supports.

The wide coverage speaker 10 is configured to provide a low-frequency response in addition to an upper-frequency (mid-range and/or high-range) response over a wide area, thereby reducing the number of separate speakers required in a given space and providing a higher uniformity of sound dispersion. This configuration can eliminate the need for separate subwoofers and reduce the quantity of pendant loudspeakers needed to provide suitable coverage as compared to known downward-firing speakers.

The wide coverage speaker 10 has an enclosure 12 with a top 13 and a bottom 15 and a central longitudinal axis 17 extending therebetween. The enclosure 12 can take a variety of forms and include various sub-components therein. In at least some embodiments, the enclosure 12 has a tapered cylindrical shape, although other shapes can be utilized to provide an aesthetic or functional modification. In at least some embodiments, the enclosure 12 is not visually or physically excessive—i.e. a size and weight that can be reasonably carried up a ladder and suspended by a single person, and a length/width profile that is not much larger than current pendant offerings, for example in at least some embodiments, the wide coverage speaker is less than twenty-eight pounds (e.g., 22 pounds) and has a height of about 19 inches and a diameter of about 12 inches.

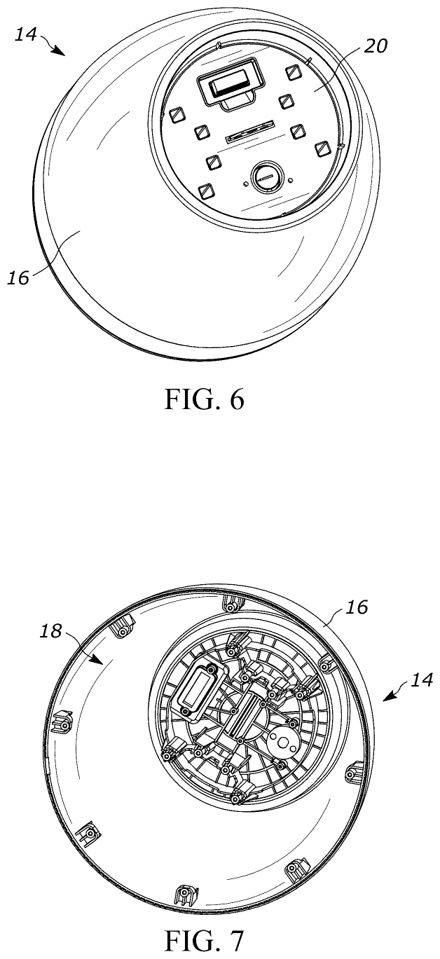

Referring to FIGS. 6-7, in at least some embodiments, the enclosure 12 includes an upper body 14 having an upper body outer surface 16 surrounding an inner low-frequency cavity 18. An upper body top plate 20 is integrally formed or otherwise secured to the upper body 14. In at least some embodiments, the upper body 14 can have a tapered cylindrical shape that increases in diameter as it extends downward, or take other shapes.

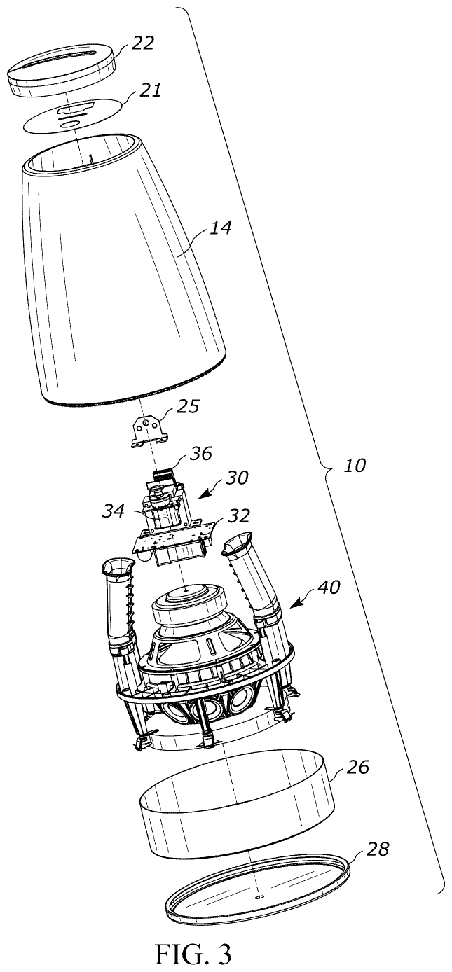

Referring again to FIGS. 3-5, in at least some embodiments, the enclosure 12 can further include an aesthetic cover plate 21 and a top cover 22 with a slot 24 to pass a pendant wire or rod therethrough, which can be connected to an anchor plate (i.e., hanging bracket) 25 secured with the enclosure 12 to facilitate pendant mounting. In addition, the enclosure 12 can include a side screen 26 situated below the upper body 14 and a bottom screen 28 situated at the bottom of the enclosure 12, wherein the screens 26 and 28 allow sound to readily pass therethrough, comprising of a material such as porous fabric, attenuating foam, etc.

In addition to the enclosure 12, the wide coverage speaker 10 includes a circuit assembly 30. In at least some embodiments, the circuit assembly 30 includes a crossover 32 (e.g., a second-order crossover, etc.) and a transformer 34 (e.g., 70/100V, etc.), along with one or more connectors 36 to receive input signals from an amplifier. The transformer 34 may be provided to reduce current and therefore minimize power loss and voltage drop across the wiring, such as by converting a low-impedance output of an amplifier into a high-voltage, low-current signal. The use of crossovers and transformers to process input signals from amplifiers is generally known, and other known circuit components (e.g., wiring, diodes, resistors, fuses, capacitors, solid state devices, etc.) can be included in the circuit assembly 30 as necessary to facilitate the processing of input signals received from a connected amplifier and communicating processed signals to select drivers in the wide coverage speaker 10.

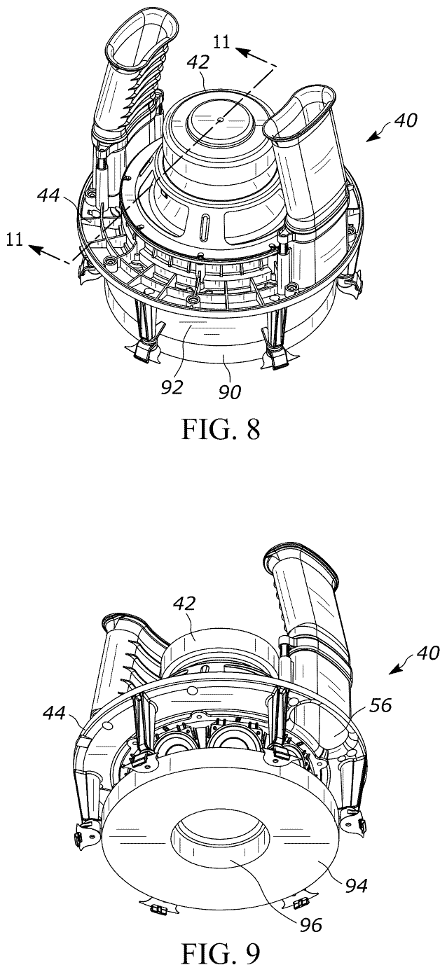

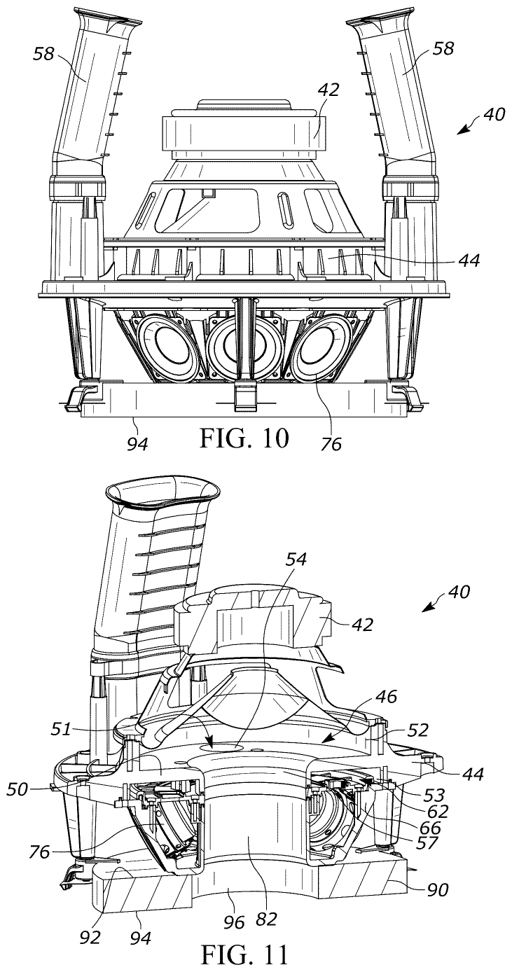

The wide coverage speaker 10 further includes an inner sound assembly 40, shown in FIGS. 8-14 in various views. The inner sound assembly 40 includes a assembly central axis 41, which in at least some embodiments is coincident with the central longitudinal axis 17 of the enclosure. The inner sound assembly 40 includes various drivers and ports to produce the desired frequency response from the wide coverage speaker 10. More particularly, to provide an extended low-frequency response, in at least some embodiments, a woofer 42 (i.e., low-frequency driver), for example, an eight-inch woofer, is mounted inside the low-frequency cavity 18 and can be tuned to provide enough low frequency extension such that a separate subwoofer may not be necessary to provide a suitable low frequency response, in at least most applications.

The inner sound assembly 40 further includes an upper frame 44 for securing various components and directing sound. In at least some embodiments, the upper frame 44 forms at least in part, an upper chamber 46 situated above and separated from a lower chamber 48 by an upper chamber floor 50, wherein the upper chamber floor 50 includes a center aperture 57, which in at least some embodiments is cylindrical. The upper frame 44 includes an upper cylindrical wall 52 extending upwards from the upper chamber floor 50, wherein the woofer 42 is mounted atop the wall 52 facing downwards. In at least some embodiments, the woofer 42 is mounted directly on the wall 52 such that the woofer 42 provides a direct ceiling for the upper chamber 46, with no components situated therebetween. The upper frame 44 also includes a lower cylindrical wall 53 extending downward that forms in part, the lower chamber 48, with the upper chamber floor 50 serving as the ceiling for the lower chamber 48. The upper frame 44 can also include one or more low frequency ports 56 extending therethrough, which can include port tubes 58 situated thereon. The low frequency ports 56 and port tubes 58 direct low-frequency sound (created from the back of the woofer 42) out of the low-frequency cavity 18. The inner sound assembly 40 can further include a center plate 60 secured to the upper frame 44 and situated below the upper chamber floor 50 to form a lower chamber floor 62.

In at least some embodiments, the inner sound assembly 40 further includes a tuned low-frequency absorber 51. The tuned low-frequency absorber 51 can vary in type, size, shape, and quantity, although in at least some embodiments, as shown, they are Helmholtz absorbers, which include one or more generally cylindrical necks 54 that extend downward through the upper chamber floor 50 and into the lower chamber 48. The necks 54 and lower chamber 48 cooperate to provide the tuned low-frequency absorption. In other embodiments, the wide coverage speaker 10 can utilize other types of low-frequency absorber, such as membranes or panels in addition to or in place of a Helmholtz absorber. In at least some embodiments, the tuned low-frequency absorber 51 is included to absorb cylindrical modes resulting from the low-frequency cavity's physical dimensions, these absorbers can vary in size, shape, and quantity. This enables the low-frequency passband to operate up to the crossover point without significant polar narrowing or lobing, and with a consistent frequency response without cavity modes.

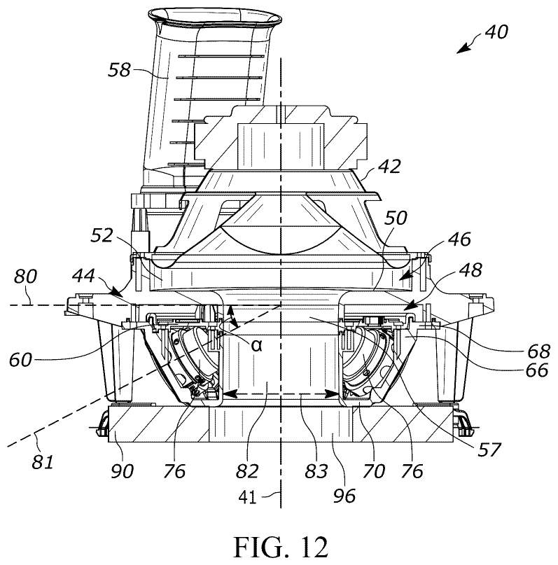

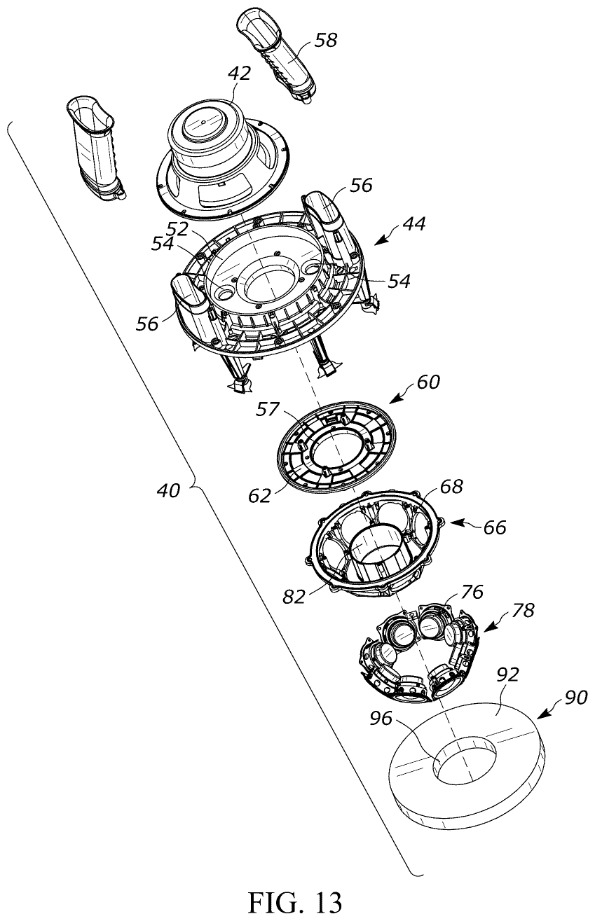

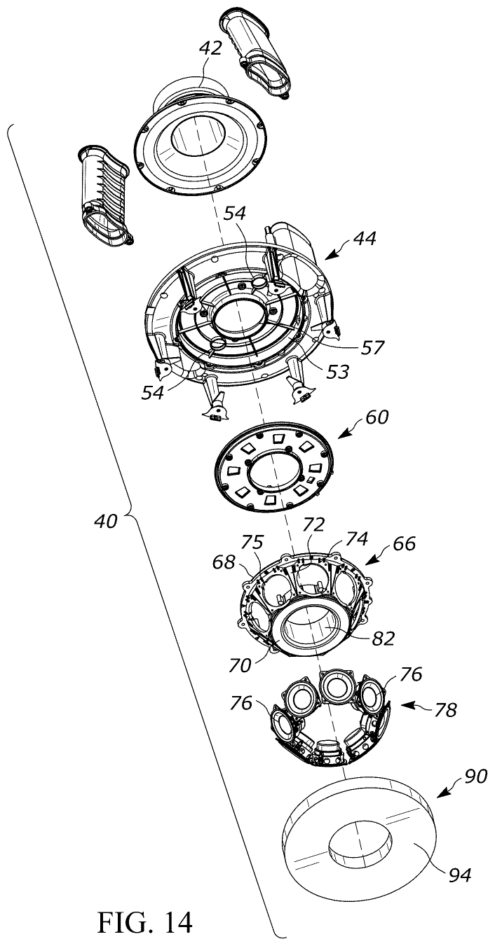

Referring to FIGS. 13 and 14, the inner sound assembly 40 can further include a lower frame 66 situated below the center plate 60. In at least some embodiments, the lower frame 66 includes a lower frame top 68 and a lower frame bottom 70, both circular and centered on the assembly central axis 41. A plurality of faceted windows 74 connect the lower frame top 68 to the lower frame bottom 70, with the windows 74 having apertures 75 that are sized and shaped to mount a plurality of upper-frequency drivers 76 (i.e., mid-range and/or high-range drivers) at least partially therein in an outwardly facing direction, thereby providing a circular array 78 of upper-frequency drivers 76 centered on the assembly central axis 41. In at least some embodiments, the lower frame top 68 has a larger circumference than the lower frame bottom 70. As such, a directional driver center line 81 extending orthogonal to the windows 74 and through (back-to-front) at least one of the associated upper-frequency drivers 76, is at a downward angle α from a horizontal plane 80 that intersects perpendicular to the assembly central axis 41 (see FIG. 12). In at least some embodiments, the angle α is the same for all of the upper-frequency drivers 76, while in other embodiments the angle α can vary for each upper-frequency driver 76. While the angle α can vary, in at least some embodiments, angle α is between about ten degrees and about seventy degrees, and in some other embodiments, is between about 25 degrees and about forty-five degrees, and yet in some further embodiment is about thirty degrees, to provide an optimized projection of upper-frequency energy to the edge of a coverage pattern.

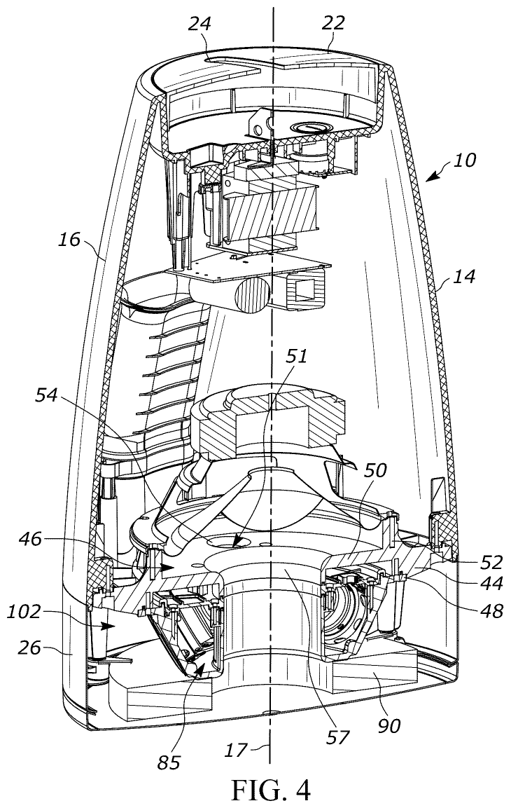

The inner sound assembly 40 includes a cylindrical low-frequency outlet port 82 with an exit diameter 83. In at least some embodiments, the outlet port 82 is formed with the lower frame 66 and extends upward from the lower frame bottom 70 to the center aperture 57 to provide a continuous low-frequency outlet from the upper chamber 46, while in other embodiments, the outlet port 82 can extend from or be secured to, the upper frame 44 or another component. In at least some embodiments, a driver cavity 85 (see FIG. 4) is situated below the lower chamber 48, between the outlet port 82 and the windows 74, with the lower chamber floor 62 serving as a ceiling for the driver cavity 85. Sound from the woofer 42 passes into the upper chamber 46 and is tuned by the low-frequency absorber 51 before passing through the outlet port 82, which in at least some embodiments, provides wide horizontal low-frequency directivity, and has a relatively short length to minimize the apparent source size and place it close to the upper-frequency drivers 76.

In at least some embodiments, the exit diameter 83 of the outlet port 82 can be critical, being much smaller than the diameter of the woofer 42 in order to produce a horizontal directivity that is wider than the natural directivity of the woofer 42. For example, in the embodiment illustrated herein, using an eight-inch woofer, the exit diameter 83 of the outlet port 82 is about four inches (although other sizes could be utilized in other embodiments), to create a source that is significantly smaller than the wavelength of sound at the crossover point of the upper-frequency drivers 76 while providing the output of the eight-inch woofer 42. In at least some other embodiments, this arrangement could be employed with a woofer 42 and array 78 of varying sizes, by adjusting the exit diameter 83 depending on the low-frequency cutoff of the array 78 and the desired horizontal directivity.

The array 78 of upper-frequency drivers 76 encircle the outlet port 82 and project sound in a symmetrical circle around the wide coverage speaker 10. In at least some embodiments, the array 78 can include eight two-inch upper-frequency drivers 76, which project sound in a symmetrical circle around the wide coverage speaker 10 out to a distance of about twenty-five feet from the central longitudinal axis 17 of the enclosure 12, although in at least some other embodiments, more or less upper-frequency drivers 76 can be used, and/or having a larger or smaller diameter. In at least some embodiments, for the array 78 of upper-frequency drivers 76 to be most effective in minimizing sidelobes, the source spacing should be less than ½-wavelength of the highest frequency intended to be reproduced. For example, in the present embodiment, a two-inch upper-frequency driver 76 spacing ensures consistent reproduction up to 3300 Hz, beyond which the natural directivity of each upper-frequency driver 76 isolates its output from the neighboring upper-frequency driver 76, reducing lobing. In at least one embodiment, as shown, the upper-frequency drivers 76 include cone drivers to enable the crossover point from woofer to upper range to be exceptionally low—between 400 and 500 Hz—providing the majority of the voice range to emanate from the upper-frequency drivers 76 without the interruption of a crossover point. Although in other embodiments, dome or compression drivers could also be used.

While a circular array has many benefits, a related result is summation directly beneath the array where the listener is equidistant from all upper-frequency drivers 76. To mitigate this, in at least some embodiments, the inner sound assembly 40 can further include a bottom directivity disk 90 having a disk top surface 92 and a disk bottom surface 94. In at least some embodiments the bottom directivity disk 90 includes a central disk aperture 96 extending therethrough. The bottom directivity disk 90 is positioned to shadow the area directly below this summation and serves to smooth out the transition from far- to near-field and reduce the “hot spot” directly beneath the array 78 so that the sound is very similar beneath the array and at the edge of the coverage.

An important design element of the bottom directivity disk 90 can be its acoustic absorption and physical size. In at least some embodiments, the bottom directivity disk 90 is comprised of a layer of material that is acoustically absorptive (absorption coefficient greater than 0.8) above 1 kHz to reduce sound from the upper-frequency drivers 76 transmitted downward, while also minimizing reflections of sound back up into a bottom chamber 102 surrounding the upper-frequency drivers 76, while in other embodiments, other acoustically absorptive materials can be used. Additionally, the bottom directivity disk 90 is of a sufficient physical size, for example, twelve inches in diameter for the present embodiment shown, to provide a shadowing effect beginning at approximately 1 kHz, where the wavelength of sound approaches one foot.

As discussed above, the wide coverage speaker 10 includes a circuit assembly 30 with a crossover 32. Various types of crossovers can be utilized. In at least some embodiments, the wide coverage speaker 10 includes a second-order passive crossover that integrates the woofer 42 and upper-frequency drivers 76 to provide a flat overall response. Additionally, active equalization can be provided to increase “smoothness” and provide some additional lower frequency punch. In at least some embodiments, only a single amplifier channel is needed. In at least some embodiments, such as in the exemplary embodiment shown herein, a peak power level of 140 W is required to reach maximum output.

In at least some embodiments, in an exemplary configuration, the wide coverage speaker 10 allows for minimum of at least forty feet of usable diameter of coverage from a single wide coverage speaker 10 when hung at twelve feet above the finished floor, or a fifty feet diameter when hung at fourteen feet. Known pendant loudspeakers typically have a 100-degree conical pattern that produce a nominal coverage area (−6 dB) ˜twenty-eight feet at a ten foot height, whereas in at least some embodiments, the wide coverage speaker 10 has a one-hundred and forty degree pattern that can produce a nominal coverage area (−6 dB) of fifty-five feet at the same height, thereby reducing the quantity of speakers needed for a given application by a factor of approximately 2.

In at least some embodiments, the wide coverage speaker 10 can include any one or more of the following performance specifications: system frequency response of 50 Hz-15 kHz (−3 dB); frequency range of 40 Hz-20 kHz (−10 dB); nominal coverage (1-4 kHz) 140 degrees conical; system high-pass filter with 40 Hz HPF; max SPL @ 1 Meter, continuous of 107 dB, and peak of 113 dB; nominal impedance system of eight ohms; dispersion 1-10 khz of 140 degrees with 10-14 ft grille-to-floor hanging heights, and 40 ft coverage per wide coverage speaker 10 at 12 ft, and 50 ft coverage per wide coverage speaker 10 at 14 ft; 70/100V taps rated 100/50/25/12 W; input connection of 6-pin euroblock input for Lo-Z/Hi-Z; maximum dimension of the enclosure not exceed a 19.4 inch height (not including hook)×12.1 inch diameter; weight not to exceed 27 lbs. In addition, in at least some embodiments, the wide coverage speaker 10 can be pre-configured with one or more of various software interfaces, such as GoldFinch Presets, CSD & CSP presets, SmartBass, EASE, and/or Modeler.

Various aspects of the wide coverage speaker can be modified within the spirit of the invention. In addition to the disclosed shapes and sizes (e.g., cylindrical, tubular, conical, tapered, etc.), all the aforementioned components, can vary to include numerous adaptations. Further, the material composition of all components can also include numerous elements, such as steel, aluminum, alloys, plastics, etc. It shall be understood that the term “about” when referencing a numerical dimension or range can in at least some embodiments, be construed to include an exact number, while in other embodiments it may be construed to include a number that is reasonably close, such as within manufacturing tolerances.

What is claimed is:

1. A wide coverage speaker comprising:
an enclosure having a top, a bottom, a central longitudinal axis extending therethrough, and a low frequency cavity therein; and
an inner sound assembly situated within the enclosure and having an assembly central axis therethrough, the inner sound assembly comprising:
a woofer positioned facing downward within the low frequency cavity and centered about the assembly central axis;
an upper chamber situated below the woofer;
a tuned low-frequency absorber situated below and in fluid communication with the upper chamber;
a plurality of upper-frequency drivers facing outwards in a circular array that is centered about the assembly central axis and situated below the tuned low-frequency absorber; and
a cylindrical low-frequency outlet port centered about the assembly central axis and extending downward from the upper chamber and encircled by the circular array.

2. The wide coverage speaker of claim 1, further comprising a circuit assembly including a crossover, for directing lower frequency signals to the woofer and upper frequency signals to the plurality of upper-frequency drivers.

3. The wide coverage speaker of claim 1, wherein the central longitudinal axis and the assembly central axis are coincident.

4. The wide coverage speaker of claim 3, wherein a directional driver center line passing through at least one of the plurality of upper-frequency drivers extends at a downward angle from a horizontal plane that intersects perpendicular to the assembly central axis.

5. The wide coverage speaker of claim 4, further comprising at least one low-frequency port in fluid communication with the low frequency cavity.

6. The wide coverage speaker of claim 5, further comprising an acoustically absorptive bottom directivity disk situated below the circular array and centered along the assembly central axis.

7. The wide coverage speaker of claim 5, wherein the tuned low-frequency absorber includes a lower chamber and a first cylindrical neck extending from the upper chamber into the lower chamber such that the lower chamber and the upper chamber are in fluid communication.

8. The wide coverage speaker of claim 7, wherein the tuned low-frequency absorber includes a second cylindrical neck situated opposite the first cylindrical neck.

9. The wide coverage speaker of claim 7, wherein the at least one low-frequency port includes two low-frequency ports symmetrically situated about the central longitudinal axis on opposing sides of the inner sound assembly and in fluid communication with the low frequency cavity.

10. The wide coverage speaker of claim 7, wherein the inner sound assembly further comprises an upper frame having an upper chamber floor from which an upper cylindrical wall extends upwards, the woofer being mounted facing downwards atop the upper cylindrical wall, wherein the upper chamber floor, the upper cylindrical wall, and the woofer combine to form the upper chamber.

11. The wide coverage speaker of claim 10, wherein the inner sound assembly further comprises a lower frame that includes a plurality of faceted windows having apertures into which the plurality of upper-frequency drivers are secured.

12. The wide coverage speaker of claim 11, wherein the lower frame includes a lower frame top and a lower frame bottom, which are both circular and centered on the assembly central axis, with the plurality of faceted windows connecting the lower frame top to the lower frame bottom, wherein the lower frame top has a larger circumference than the lower frame bottom.

13. The wide coverage speaker of claim 12, wherein the inner sound assembly further comprises a center plate secured between the upper frame and the lower frame, and wherein the center plate forms a lower chamber floor.

14. The wide coverage speaker of claim 13, further comprising an acoustically absorptive bottom directivity disk situated below the circular array and centered along the assembly central axis, wherein the acoustically absorptive bottom directivity disk is comprised of material that is acoustically absorptive above about 1 kHz and includes a central disk aperture extending therethrough.

15. The wide coverage speaker of claim 5, wherein the woofer is an eight-inch woofer; the plurality of upper-frequency drivers are each two-inch cone drivers; an exit diameter of the cylindrical low-frequency outlet port is about four inches; the directional driver center line extending through at least one of the plurality of upper-frequency drivers is at about a thirty degree angle from the horizontal plane; a circuit assembly is provided that includes a second-order passive crossover electrically coupled to integrate the woofer and the plurality of upper-frequency drivers to provide a flat overall response; the tuned low-frequency absorber is a Helmholtz absorber; and an acoustically absorptive bottom directivity disk is provided that is comprised of material that is acoustically absorptive above 1 kHz.
